(19) United States
(12) Patent Application Publication
(10) Pub. No.: US 2012/0158509 A1
(43) Pub. Date: Jun. 21, 2012

(54) Price Formation in Location-Based Advertising Networks

(75) Inventors: Aleksandar Zivkovic, North York (CA); Marvin Igelman, Thornhill (CA)

(73) Assignee: POYNT CORPORATION

(21) Appl. No.: 13/270,540

(22) Filed: Oct. 11, 2011

Related U.S. Application Data
(60) Provisional application No. 61/423,450, filed on Dec. 15, 2010.

(51) Int. Cl. G06Q 30/02

(52) U.S. Cl. 705/14.58

(57) ABSTRACT

A method of providing a location-based advertisement is provided. The advertisement is provided to an electronic communications device, over a communications network, on behalf of an advertiser. The method includes calculating an adjusted price to be charged to the advertiser for the advertisement using at least a geographic location associated with the advertisement, a distance of the electronic communications device from the geographic location and optionally a bid price associated with the geographic location. The method also includes delivering the advertisement over the communications network to the electronic communications device. A system for providing such advertisements, as well as a computer-readable storage medium with instructions, in the form of software, to perform the method or implement the system are also provided.

### CROSS REFERENCE TO RELATED APPLICATIONS

This application claims the benefit of U.S. Provisional Patent Application No. 61/423,450 filed Dec. 15, 2010, titled “Price Formation in Location-Based Advertising networks,” the entire contents of which are hereby incorporated by reference herein, for all purposes.

### TECHNICAL FIELD

The present invention relates to location-based advertising systems, and more particularly to systems for automatically delivering such advertisements and calculating prices for the delivered advertisements.

### BACKGROUND ART

Selecting advertisements to be delivered to mobile communication devices based on locations of the mobile communications devices is well known. Such advertisements are known as “location-based advertisements” (LBAs). For example, a location-based advertisement system might display an advertisement for a coffee shop when a user is within a predetermined distance of the coffee shop. In some cases, other factors are also used to select advertisements, such as known user preferences or known demographic information about the users.

In general, advertisers would prefer to pay advertising fees that are correlated with likelihood that purchased advertisements will elicit desired responses, such as inducing a user to purchase an advertised product or service. However, known location-based advertising systems are incapable of setting advertising fees based on the likelihood of success of purchased advertisements.

### SUMMARY OF EMBODIMENTS

There are provided methods and systems for providing location-based advertisements on behalf of advertisers, and non-transitory computer program products having computer code thereon for performing the methods and implementing the systems.

An embodiment of the present invention provides a computer-implemented method for providing a location-based advertisement, over a communications network, to an electronic communications device. The advertisement is provided on behalf of an advertiser. The advertisement has an associated geographic location. A geographic location of the electronic communications device is automatically ascertained. An adjusted price for delivering the advertisement to the electronic communications device is automatically calculated. The adjusted price is calculated based at least on the ascertained geographic location of the electronic communications device and the geographic location associated with the advertisement. The advertisement is automatically delivered over the communications network to the electronic communications device, and the delivered advertisement is displayed by the electronic communications device.

Optionally or alternatively, the adjusted price for delivering the advertisement may be automatically calculated based at least in part on an initial price associated with the geographic location associated with the advertisement. An invoice that includes the automatically calculated adjusted price for delivering the advertisement may be automatically generated. The automatically calculated adjusted price for delivering the advertisement may be automatically stored in a computerized database, in association with an account of the advertiser.

An automatically generated request for a location-based advertisement may be received from the electronic communications device. In response to receiving the automatically generated request for the location-based advertisement, the adjusted price for delivering the advertisement may be automatically calculated, and the advertisement may be automatically delivered.

An adjusted price for delivering each of a plurality of location-based advertisements to the electronic communications device may be automatically calculated. Each of the plurality of location-based advertisements may have a respective associated geographic location. Each adjusted price may be calculated based at least on: the ascertained geographic location of the electronic communications device and the geographic location associated with the respective advertisement. In addition, at least one of the location-based advertisements may be automatically selected, based at least in part on the respective calculated adjusted prices for the plurality of location-based advertisements. The automatically selected one or more location-based advertisements may be automatically delivered over the communications network to the electronic communications device. The automatically delivered selected at least one location-based advertisement may be displayed by the electronic communications device.

The adjusted price may be automatically calculated, based at least in part on an initial price associated with the geographic location associated with the respective location-based advertisement.

The at least one of the plurality of location-based advertisements may be probabilistically selected, based at least in part on a ratio of (a) the calculated adjusted price for delivering each of the plurality of location-based advertisements and (b) a sum of the calculated adjusted prices for delivering the plurality of location-based advertisements.

The at least one of the plurality of location-based advertisements may be selected, such that distance between each selected location-based advertisement's associated geographic location and the ascertained geographic location of the electronic communications device is less than a predetermined value.

The adjusted price for delivering the advertisement may include calculating a Gaussian function according to:

$$f ( x ) = b {e}^{- \frac{{( x - a )}^{2}}{2 {c}^{2}}}$$

where x is distance, a defines a location of a peak of the Gaussian function, b is a height of the peak and c is a parameter defining a shape of the Gaussian function.

The adjusted price for delivering the advertisement may include calculating a Gaussian function according to:

ƒ(x)=mx+b

where x is distance, m defines a rate of drop-off and b determines a value of ƒ(x) when the distance is zero.

The adjusted price for delivering the advertisement may include calculating the adjusted price according to a bimodal Gaussian function.

The adjusted price for delivering the advertisement may include calculating the adjusted price according to at least one of (a) a population density; (b) an estimated travel time between the geographic location associated with the advertisement and the ascertained geographic location of the electronic communications device; and (c) an estimated travel distance between the geographic location associated with the advertisement and the ascertained geographic location of the electronic communications device.

Optionally, an electronic communication may be received from an advertiser. The electronic communication may include information about the location-based advertisement and the geographic location associated with the location-based advertisement. The received information about the location-based advertisement may be stored in a computerized database. In addition, the geographic location associated with the location-based advertisement may be stored in the computerized database.

An electronic communication may be received from the advertiser. The electronic communication may included the initial price associated with the geographic location associated with the location-based advertisement. The received the initial price may be stored in the database.

Another embodiment of the present invention provides a computerized system for providing a location-based advertisement, on behalf of an advertiser, over a communications network, to an electronic communications device. The advertisement may have an associated geographic location. The system includes a location determination module configured to automatically ascertain a geographic location of the electronic communications device. A price determination module may be coupled to the location determination module. The price determination module may be configured to automatically calculate an adjusted price for delivering the advertisement to the electronic communications device. The adjusted price may be calculated based at least on: (a) the ascertained geographic location of the electronic communications device; and (b) the geographic location associated with the advertisement. An advertisement sender may be coupled to the price determination module. The advertisement sender may be configured to automatically deliver the advertisement over the communications network to the electronic communications device and cause display of the delivered advertisement by the electronic communications device.

The price determination module may be configured to automatically calculate the adjusted price for delivering the advertisement based at least in part on an initial price associated with the geographic location associated with the advertisement.

The system may include an invoice generator coupled to the price determination module. The invoice generator may be configured to automatically generate an invoice that includes the automatically calculated adjusted price for delivering the advertisement.

The invoice generator may be further configured to automatically store the automatically calculated adjusted price for delivering the advertisement. The automatically calculated adjusted price may be stored in a computerized database, in association with an account of the advertiser.

Optionally, an advertisement request receiver may be coupled to the price determination module. The advertisement request receiver may be configured to receive an automatically generated request for a location-based advertisement. The automatically generated request may be received from the electronic communications device.

The price determination module may be further configured to automatically calculate the adjusted price for delivering the advertisement in response to receipt of the automatically generated request for the location-based advertisement.

The advertisement sender may be further configured to automatically deliver the advertisement in response to receipt of the automatically generated request for the location-based advertisement.

The price determination module may be further configured to automatically calculate an adjusted price for delivering each of a plurality of location-based advertisements to the electronic communications device. Each of the location-based advertisements may have a respective associated geographic location. Each adjusted price may be calculated based at least on several factors, such as the ascertained geographic location of the electronic communications device; and the geographic location associated with the respective advertisement. In addition, an advertisement selector may be coupled to the price determination module. The advertisement selector may be configured to automatically select at least one of the plurality of location-based advertisements, based at least in part on the respective calculated adjusted prices for the plurality of location-based advertisements. The advertisement sender may be further configured to automatically deliver the automatically selected at least one of the location-based advertisements over the communications network to the electronic communications device and cause display by the electronic communications device of the automatically delivered selected at least one of the plurality of the location-based advertisements.

Each adjusted price may be calculated based at least on an initial price associated with the geographic location associated with the respective location-based advertisement.

The advertisement selector may be further configured to automatically probabilistically select the at least one of the plurality of location-based advertisements. The selection may be based at least in part on a ratio of: (a) the calculated adjusted price for delivering each of the plurality of location-based advertisements; and (b) a sum of the calculated adjusted prices for delivering the plurality of location-based advertisements.

The advertisement selector may be further configured to automatically select the at least one of the plurality of location-based advertisements, such that distance between each selected location-based advertisement's associated geographic location and the ascertained geographic location of the electronic communications device is less than a predetermined value.

The price determination module may be further configured to calculate the adjusted price for delivering the advertisement according to a Gaussian function:

$$f ( x ) = b {e}^{- \frac{{( x - a )}^{2}}{2 {c}^{2}}}$$

where x is distance, a defines a location of a peak of the Gaussian function, b is a height of the peak and c is a parameter defining a shape of the Gaussian function.

The price determination module may be further configured to calculate the adjusted price for delivering the advertisement according to a bimodal Gaussian function.

The price determination module may be further configured to calculate the adjusted price for delivering the advertisement according to at least one of: (a) a population density; (b) an estimated travel time between the geographic location associated with the advertisement and the ascertained geographic location of the electronic communications device; and (c) an estimated travel distance between the geographic location associated with the advertisement and the ascertained geographic location of the electronic communications device.

Optionally, the system includes an advertisement receiver configured to receive an electronic communication from an advertiser. The electronic communication may include information about the location-based advertisement and the geographic location associated with the location-based advertisement. The advertisement receiver may be further configured to store the received information about the location-based advertisement and the geographic location associated with the location-based advertisement in a computerized database.

The advertisement receiver may be further configured to receive an electronic communication from the advertiser. The electronic communication may include the initial price associated with the geographic location associated with the location-based advertisement. The advertisement receiver may be further configured to store the received the initial price in the database.

Yet another embodiment of the present invention provides a computer program product for providing a location-based advertisement, on behalf of an advertiser, over a communications network, to an electronic communications device. The advertisement may have an associated geographic location. The computer program product includes a non-transitory computer-readable medium having computer readable program code thereon. The computer readable program may include program code for automatically ascertaining a geographic location of the electronic communications device. The computer readable program may also include program code for automatically calculating an adjusted price for delivering the advertisement to the electronic communications device. The adjusted price may be calculated based at least on: (a) the ascertained geographic location of the electronic communications device; and (b) the geographic location associated with the advertisement. The computer readable program may also include program code for automatically delivering the advertisement over the communications network to the electronic communications device and causing display of the delivered advertisement by the electronic communications device.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of a location-based advertising network in accordance with an embodiment of the present invention.

FIG. 2 is a schematic flow chart of a process for providing a location-based advertisement to a user in accordance with an embodiment of the present invention.

FIG. 3 is a graph of exemplary Gaussian probability distributions for use in an embodiment of the present invention.

FIG. 4 is a schematic block diagram of a location-based advertising network in accordance with an embodiment of the present invention.

FIG. 5 is a schematic block diagram of the server of FIGS. 1 and 4, according to an embodiment of the present invention.

### DETAILED DESCRIPTION OF SPECIFIC EMBODIMENTS

In accordance with preferred embodiments of the present invention, methods and apparatus are disclosed for providing a location-based advertisement. The location-based advertisement is provided on behalf of an advertiser, over a communications network, to an electronic communications device. The advertisement may have an associated geographic location.

Definitions. As used in this description and the accompanying claims, the following terms shall have the meanings indicated, unless the context otherwise requires:

A “geographic location” refers to a single defined point in 1-dimensional, 2-dimensional or 3-dimensional space. “1-dimensional space” may be along a straight or curved line, such as a rail road line or a road. “2-dimensional space” may be within a flat or curved surface, such as all or part of the surface of the earth. “3-dimensional space” may be within a volume, such as a volume extending above and/or below the surface of the earth. Exemplary volumes include the volumes of one or more buildings and volumes that include flight paths of aircraft and spacecraft.

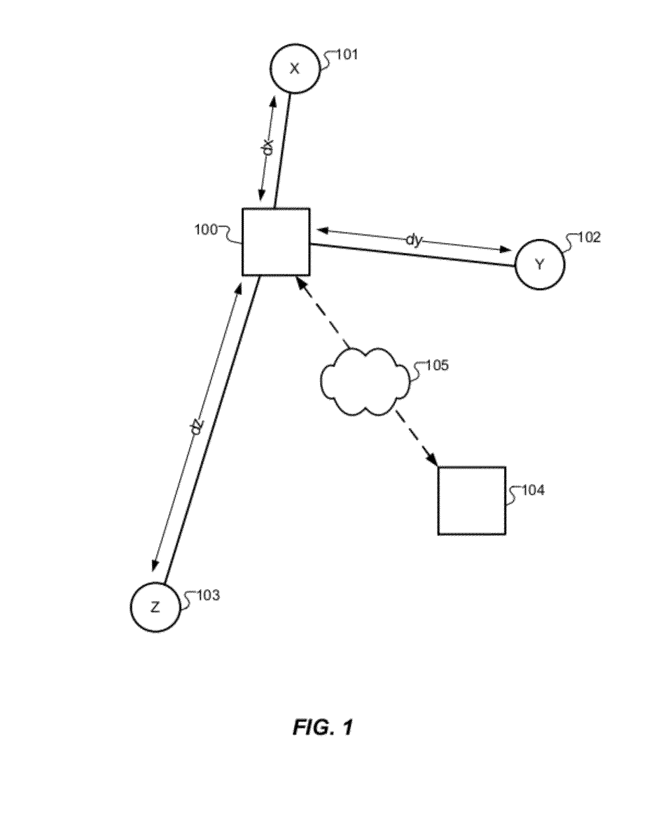

FIG. 1 is a schematic representation of a location-based advertising network in accordance with an embodiment of the present invention. A user possesses a wired or wireless electronic communications device 100, such as a cell phone, internet-enabled computer, etc., that is capable of receiving and displaying a location-based advertisement. Geographic locations 101, 102, and 103 are associated with location-based advertisements X, Y, and Z, respectively. The geographic locations 101-103 may, for example, be locations of stores or other establishments where goods or services described in the advertisements X-Z, respectively, may be offered for sale. Optionally or alternatively, the geographic locations 101-103 may be locations, such as waiting areas of airports, where advertisers prefer to have their advertisements seen by prospective customers, but are not necessarily locations where the advertised goods or services are available for purchase.

In the illustrative embodiment of FIG. 1, advertisements X, Y, and Z are the only advertisements available in the location-based advertising network. Practical embodiments, however, may include any number of advertisements, in many cases greatly exceeding the three advertisements shown here for explanatory purposes. The electronic communications device 100 is in communication with a server 104 through a wired or wireless electronic communications network 105, and may request location-based advertisements from the server 104. In some embodiments, such requests may be periodic, occurring at preset time intervals. In other embodiments, requests may be generated in response to actions taken at the electronic communications device, such as a user submitting a text query, navigating to a web page, using a local application, traveling to a geographic location or to a location that is within a predetermined distance of a geographic location, etc. Optionally or alternatively, the server 104 may “push” the location-based advertisements to the electronic communications device 100 in response to similar events (periodic, responsive to text query, web page navigation, etc.), without the electronic communications device 100 explicitly requesting an advertisement. Various suitable electronic communications networks, such as cellular telephone networks, WiFi networks, the Internet and satellite networks, are known in the art.

The server 104 acquires information relating to the geographic location of the electronic communications device 100, such as using a GPS receiver within the electronic communications device 100, mobile base station cell site identification technology, network triangulation (signal strength-based or time-based) or the like, as is well known in the art. The geographic location of the electronic communications device 100 is used in selecting and providing a location-based advertisement, and the geographic location may be relevant to both the particular advertisement selected and the cost to the advertiser the system charges for providing the advertisement. The server 104 stores information about the advertisements X, Y and Z and the locations associated with the advertisements X, Y, and Z, such as in a database 106 or in a remote database (not shown) that is accessible via the network 105 or another network (not shown). The server is thus able to calculate distances between the electronic communications device 100 and the locations associated with the advertisements.

For advertisements X, Y, and Z, these distances are labeled dx, dy and dz, respectively. Distance may be calculated in one dimension, such as along a highway or railroad line; in two dimensions, such as according to relative latitudes and longitudes; or in three dimensions, such as according to relative latitudes, longitudes and altitudes.

Generally speaking, advertisements that have geographic locations that are relatively distant from an electronic communications device 100 are assumed to be less valuable than advertisements that have geographic locations that are relatively close to the electronic communications device 100, because it is generally easier and more likely for the user of the electronic communications device to take action, such as traveling to the location associate with the advertisement, in response to becoming aware of the closer advertisement. Optionally or alternatively, an advertiser may believe that a user is more likely to be positively influenced by an advertisement if the user views the advertisement in a particular location, such as in an airport departure lounge while waiting for an airplane. Thus, according to embodiments of the present invention, prices for location-based advertisements may be determined by taking these distances into account.

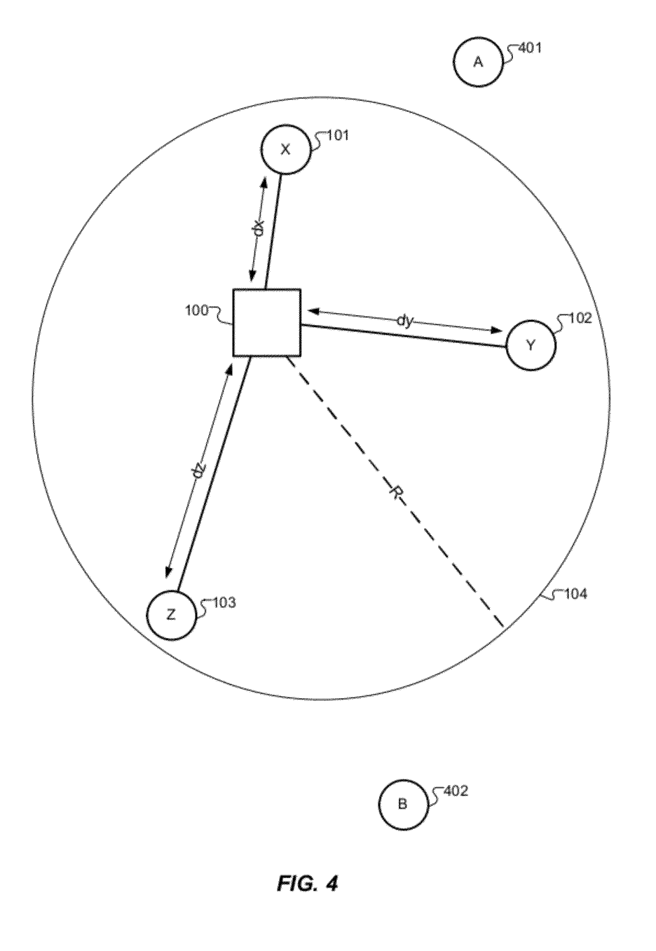

Limiting the geographic area from which advertisements are selected may help simplify implementation of systems that calculate prices and probabilities for delivering the advertisements. For example, according to an embodiment shown in FIG. 4, the server may limit the geographic area under consideration for selecting advertisements to deliver to the electronic communications device 100, based on a predetermined radius R. The invention is not, however, limited to circular areas or spherical volumes. Other geometric or irregular shapes may be used to define the geographic area. Furthermore, the term “area” is not limited to 2-dimensional areas. “Area,” as used herein, can refer to 1-dimensional ranges or 3-dimensional volumes, where appropriate. However, for simplicity of explanation, 2-dimensional circular areas are used in the following descriptions.

As noted, limiting the geographic area from which advertisements are selected may help simplify implementation of forming prices and probabilities for delivering advertisements. Without such a limit, the server may have to consider, e.g., advertisements having geographic locations spread across an entire country, nearly all of which will have extremely small, but non-zero, prices and probabilities of selection, due to the great distances from the electronic communications device. Limiting the geographic area under consideration causes the server to focus on advertisements that are close enough to have at least a certain threshold likelihood of being relevant, such that a user plausibly may take action at the geographic location in response to, or at least be influenced by, the advertisement.

A circle 403 of radius R centered at the location of the electronic communications device 100 is shown in FIG. 4. According to some embodiments, only advertisements X, Y, and Z are considered by the server in determining what advertisement to deliver to the electronic communications device 100, because the corresponding geographic locations 101, 102, and 103 are contained in the circle 403. Advertisements A and B, which are located at geographic locations 401 and 402 respectively, are not, however, eligible for delivery to the electronic communications device 100, because geographic locations 401 and 402 lie outside of the circle 403. If the electronic communications device 100 were to be taken to a new location, a new circle (not shown) of radius R centered at the new location would be considered, and the set of advertisements falling within the new circle might be different than those shown in FIG. 4.

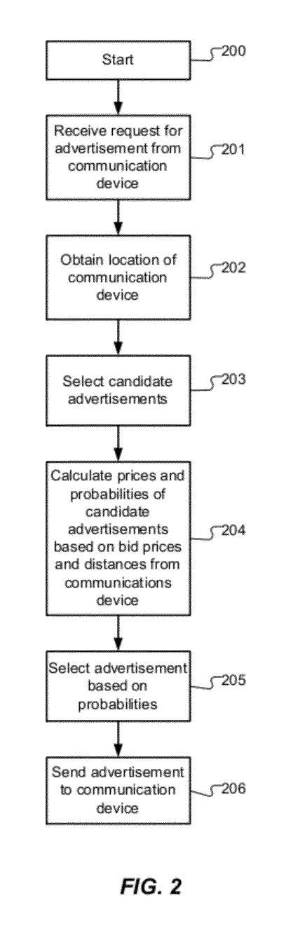

FIG. 2 is a flow chart of a process for providing a location-based advertisement to a user in accordance with an embodiment of the present invention. The process begins at block 200. At 201, a server 104 (FIG. 1) receives a request from an electronic communications device 100 (FIG. 1) for the server 104 to provide an advertisement for display to a user by the electronic communications device 100. Optionally or alternatively, the server 104 may initiate the process f selecting and delivering the advertisement, without a request from the electronic communication device 100. That is, the process may begin at 202. At 202, the server 104 obtains the geographic location of the electronic communications device 100. As noted, various techniques for obtaining geographic locations of electronic communications devices are known in the prior art, including triangulation from cell phone towers, GPS coordinates provided by the electronic communications device, predefined geographic information in a wireless Internet access point, etc., and various embodiments of the present invention are contemplated using any suitable technique or combination of techniques.

At 203, the server 104 selects one or more candidate advertisements for delivery. Selection may be performed in accordance with the exemplary embodiment, as shown in FIG. 4, by selecting all advertisements having geographic locations within a predefined distance of the electronic communications device 100. In some cases, such as when a server stores advertisements for only a specific geographic area, the server may select all known advertisements to be candidates for delivery. In some embodiments, the geographic area to be considered may be identified not by a simple straight-line distance in space, but by a metric, such as distance from the electronic communications device by car travel over existing roads, time required to travel to the target location by foot or by public transportation, or time to travel to the target by car, accounting for factors such as traffic, speed limits, road construction, etc.

Another factor that may be used as a metric in advertisement selection is population density, as factors such as traffic congestion may be closely linked to population density in an area. Accordingly, the server may calculate a metric by analyzing the distance between the electronic communications device and the geographic location of the advertisement, in combination with information relating to the population density of the associated areas, possible routes, traffic, etc. The distance may be measured according to straight-line distance. Alternatively, the distance may be measured according to how far a user would have to travel by car or another mode to arrive at the geographic location of the advertisement. The information relating to the population density could be a population density of the city, neighborhood or some other geographically or sociologically-defined region containing the geographic location of the advertisement. The population density could also be measured over an area of predefined distance from the geographic location, such as an area within a one-mile radius.

This population density value could then be used as a scaling factor to adjust the value of the distance. Alternatively, population density values associated with 1) the area containing the geographic location and 2) an area containing the electronic communications device (such as a neighborhood, city, area within a predefined distance, etc.) could be combined, such as by averaging, resulting in a value that could be used as a scaling factor.

Additional criteria for selecting advertisements may include one or more of: filtering advertisements on the basis of a text query provided by the user, filtering advertisements on the basis of information stored in a profile associated with the user (such as demographic information about the user, personal preferences relating to advertisements, user interests, etc.) and accumulated information relating to a user's browsing history or shopping history. The user profile and/or accumulated information may be stored in the database 106 or in another database accessible by the server 104.

The server then proceeds to perform calculations 204 relating to the selected candidate advertisements. The first of these calculations determines, for each of the selected candidate advertisements, a price that would be charged to the advertiser for delivering the advertisement to the electronic communications device 100 at the geographic location that was obtained at 202. The price to deliver the advertisement may be determined based on the distance between the location of the electronic communications device 100 and the geographic location associated with the advertisement, and also may be based on an initial price, such as a bid price, set by the advertiser when the advertisement was placed. The bid price may be a price offered to be paid by the advertiser as part of a competitive bidding process, such as an auction. The bid price, threshold values, factors and other values, as well as software, formulas, tables, price adjustment functions, etc., used in selecting an advertisement and calculating the price for delivering the price may be stored in the database 106 and/or in another database (not shown) accessible to the server 104.

If the electronic communications device 100 is located within a small distance of the geographic location associated with the advertisement, such that the distance between the two locations may be considered to be approximately zero, the price to deliver the advertisement may be the bid price. In the more common case that the two locations are not approximately identical, and the distance between the two is greater than zero, the price to deliver the advertisement may be calculated by applying a predetermined price adjustment function to the bid price and the distance. Generally, the price adjustment function yields a price that is less than the bid price; however, in other embodiments, the adjusted price may be equal to or greater than the bid price. It should be noted that in some embodiments, the adjusted price may be used to calculate delivery probabilities, as discussed below. However, the actual price charged to the advertiser may be different that the calculated adjusted price. An advertising network may thus be configured to charge the bid price for every delivered advertisement, irrespective of the adjusted price, while the adjusted price may be used for calculating delivery probabilities. In other cases, the actual price charged to the advertiser may be calculated based on the adjusted price.

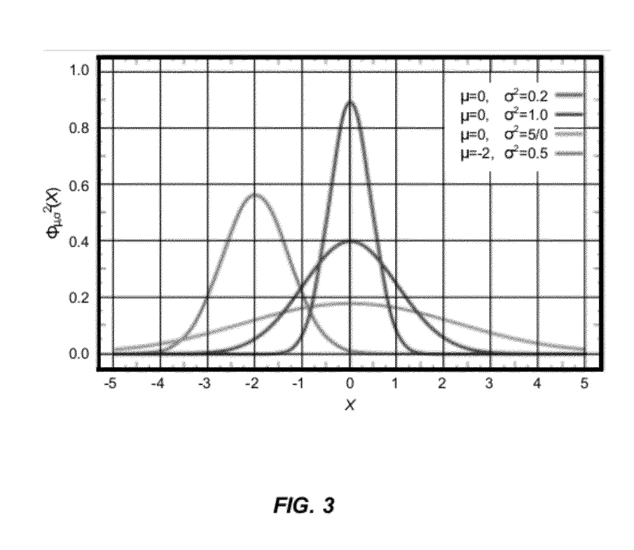

According to some embodiments, the price adjustment function may be linear with respect to distance, in which case the price decreases linearly as distance increases. In other embodiments, a step function may be used. In yet other embodiments, the price adjustment function may be a Gaussian function, such as the exemplary Gaussian functions shown in FIG. 3. An exemplary Gaussian function, ƒ(x), for use as a price adjustment function, follows the formula:

$$f ( x ) = b {e}^{- \frac{{( x - a )}^{2}}{2 {c}^{2}}} \qquad ( 1 )$$

where x is the distance, a defines a location of the peak of the Gaussian function, b is the height of the peak, and c is a parameter defining the shape of the Gaussian function, as understood in the art. In the case where a is 0, the peak is at the location associated with the advertisement. An exemplary linear function, ƒ(x), for use as a price adjustment function, follows the formula:

ƒ(x)=mx+b (2)

where x is the distance, m (slope) defines the rate of drop-off, and b determines value of ƒ(x) when the distance is zero, in which case the adjusted price may equal the bid price.

In an embodiment using a Gaussian function, the price may be set to the product of the bid price and a Gaussian function of the distance, having a peak value of 1 where the distance is 0. In other embodiments, the function may be a shifted Gaussian function, such that the peak value is reached at a distance greater than 0. A similar drop-off curve may be realized using a bimodal Gaussian function, such as may be produced according to techniques known in the art by adding two distinct Gaussian functions. In such an embodiment, the price would increase initially as the distance from the location of the advertisement increases, and after a critical distance the price would then decrease according to the Gaussian drop-off. Such an embodiment would represent an approach where it is assumed that there is less utility in driving a user to a location with an advertisement, if the user already is at the location, than if the user is merely close to the location. The functions listed above are meant to be exemplary only, and other appropriate functions may used to define relative values of providing an advertisement associated with a first location to a user in a second location.

In further embodiments, the price adjustment function may take population density into account. In these embodiments, the rate of price drop-off relative to distance from the location of the advertisement may vary based on population density. Generally speaking, densely populated areas may take longer to cross due to traffic. The likelihood that a user receiving an advertisement would choose to travel to the advertisement location may be lower if the distance to the advertisement location is moderate but the intervening area is densely populated, than if the distance to the advertisement is somewhat greater but the intervening area is sparsely populated. Similarly, the price adjustment function may adjust for relative travel times or travel distances explicitly. One of skill in the art will recognize that other metrics relating to the relative expected effectiveness of an advertisement also may be built into the pricing algorithm as appropriate.

Once adjusted prices for delivery of the candidate advertisements to the specific location of the electronic communications device have been determined, probabilities are determined for selection of each of the candidate advertisements based on the adjusted prices. According to one embodiment, the probability of selecting a particular candidate advertisement is directly proportional to the ratio between the adjusted price of the advertisement and the sum of the adjusted prices of all candidate advertisements. Optionally, this ratio may be adjusted by a small random number to cause variation in the advertisement selection process among advertisements that have identical or nearly identical ratios. When probabilities have been determined for all of the candidate advertisements, an advertisement can be selected for delivery according to various techniques known in the art.

According to one embodiment, a computer-implemented random number generator may be used. The operation of such an embodiment is now discussed with reference to FIG. 1. A numbered ordering of the candidate advertisements is chosen for indexing purposes. The three advertisements X, Y and Z from FIG. 1 may be assigned a numbered ordering according to alphabetic ordering, i.e. X is number 1, Y is number 2, and Z is number 3, although any ordering may be used. For the present example, suppose the three advertisements have probabilities of 0.5, 0.3 and 0.2, respectively. The numerical range from 0 to 1 is partitioned according to the numbered ordering and probabilities as follows: values between 0 and 0.5 correspond to advertisement X, values between 0.5 and 0.8 correspond to advertisement Y, and values between 0.8 and 1 correspond to advertisement Z. A random number is generated in a predefined range, such as between the values 0 and 1. The randomly generated number is then used to determine which advertisement is selected based on into which partition of the 0 to 1 numerical range the randomly generated number falls.

Further advertisements also may be selected as being second, third, etc. in priority according to a similar process. In the example just given, supposing that the random number generator provides a value of 0.6, advertisement Y would be selected as the first advertisement to be delivered. One of the remaining advertisements X and Z could then be selected by generating a second random number between 0 and 1. The adjusted probability of selecting X would in this case be the raw probability of selecting X divided by the sum of the probabilities of the remaining advertisements, in this case 0.5/(0.5+0.2)= 5/7, and the adjusted probability of selecting Z would be 0.2/(0.5+0.2)= 2/7 accordingly. This process could be used to generate a priority-ordered list of advertisements of any desired length in practice, when more advertisements are under consideration than the three advertisements used for illustrative purposes here.

The process of determining adjusted prices and delivery probabilities can be understood further with reference to FIG. 1. In the embodiment of FIG. 1, there are three advertisements, X, Y and Z, being distances dx, dy and dz, respectively, from the electronic communications device 100. Advertisements X, Y and Z also have associated bid prices px, py and pz. As discussed above, the adjusted prices are determined according to a function of distance, ƒ(d), such that the adjusted price, pxa, for advertisement X is ƒ(dx)*px, the adjusted price, pya, for advertisement Y is ƒ(dy)*py, and the adjusted price, pza, for advertisement Z is ƒ(dz)*pz. The probabilities for delivering each of the candidate advertisements can then be calculated using the adjusted prices as follows. The probability of delivering advertisement X may be determined as pxa/(pxa+pya+pza). Similarly, the probability of delivering advertisement Y may be determined as pya/(pxa+pya+pza), and the probability of delivering advertisement Z may be determined as pza/(pxa+pya+pza).

Once the probabilities and prices of the candidate advertisements have been determined, at 205, the server selects an advertisement based on the calculated probabilities. Then, at 206, the server delivers the selected advertisement to the electronic communications device over the electronic communications network. The advertiser that placed the delivered advertisement is charged the price that was calculated at 204.

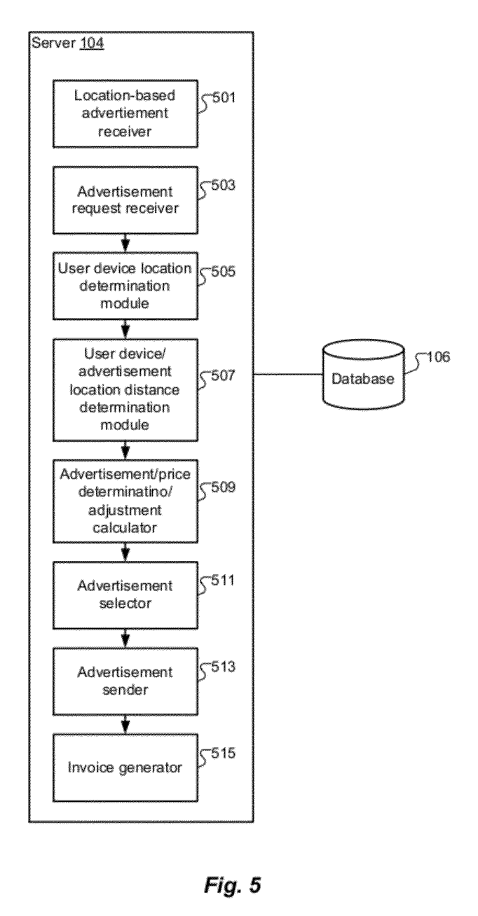

FIG. 5 is a schematic block diagram of the server of FIGS. 1 and 4, according to an embodiment of the present invention.

The present invention may be embodied in many different forms, including, but in no way limited to, computer program logic for execution by a processor. Computer program logic implementing all or part of the functionality described herein may be embodied in various forms, including, but in no way limited to, systems, source code, computer-executable code and various intermediate forms (e.g., forms generated by an assembler, compiler, linker or locator). Source code may include a series of computer program instructions implemented in any suitable programming languages (e.g., an object code, an assembly language, or a high-level language such as FORTRAN, C, C++, JAVA, or HTML) for use with suitable operating systems or operating environments. The source code may define and use various data structures and communication messages. The source code may be in a computer executable form (e.g., via an interpreter), or the source code may be converted (e.g., via a translator, assembler or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM or Flash-Programmable memory), a magnetic memory device (e.g., a diskette or fixed disk), an optical memory device (e.g., a CD-ROM), a PC card (e.g., PCMCIA card), or other suitable memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or temporarily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

A system for selecting and delivering location-based advertisements to electronic communications devices, as described herein, may include a processor controlled by instructions stored in a memory. The memory may be random access memory (RAM), read-only memory (ROM), flash memory or any other memory, or combination thereof, suitable for storing control software or other instructions and data. Some of the functions performed by the system for selecting and delivering location-based advertisements to electronic communications devices and related methods have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of the system or method for selecting and delivering location-based advertisements to electronic communications devices have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. A computer-implemented method for providing a location-based advertisement, on behalf of an advertiser, over a communications network, to an electronic communications device, the advertisement having an associated geographic location, the method comprising:
automatically ascertaining a geographic location of the electronic communications device;
automatically calculating an adjusted price for delivering the advertisement to the electronic communications device, wherein the adjusted price is calculated based at least on:
the ascertained geographic location of the electronic communications device; and
the geographic location associated with the advertisement; and
automatically delivering the advertisement over the communications network to the electronic communications device and causing display of the delivered advertisement by the electronic communications device.

2. A method according to claim 1, wherein automatically calculating the adjusted price for delivering the advertisement comprises automatically calculating the adjusted price based at least in part on an initial price associated with the geographic location associated with the advertisement.

3. A method according to claim 1, further comprising automatically generating an invoice that includes the automatically calculated adjusted price for delivering the advertisement.

4. A method according to claim 1, further comprising automatically storing, in a computerized database, the automatically calculated adjusted price for delivering the advertisement, in association with an account of the advertiser.

5. A method according to claim 1, further comprising:
receiving, from the electronic communications device, an automatically generated request for a location-based advertisement; and wherein:
automatically calculating the adjusted price for delivering the advertisement and automatically delivering the advertisement are automatically performed in response to receiving the automatically generated request for the location-based advertisement.

6. A method according to claim 1, wherein:
automatically calculating the adjusted price for delivering the advertisement comprises automatically calculating an adjusted price for delivering each of a plurality of location-based advertisements to the electronic communications device, each of the plurality of location-based advertisements having a respective associated geographic location, wherein each adjusted price is calculated based at least on:
the ascertained geographic location of the electronic communications device; and
the geographic location associated with the respective advertisement;
the method further comprising:
automatically selecting at least one of the plurality of location-based advertisements, based at least in part on the respective calculated adjusted prices for the plurality of location-based advertisements; and wherein:
automatically delivering the advertisement and causing display of the delivered advertisement comprises automatically delivering the automatically selected at least one of the plurality of the location-based advertisements over the communications network to the electronic communications device and causing display by the electronic communications device of the automatically delivered selected at least one of the plurality of the location-based advertisements.

7. A method according to claim 6, wherein automatically calculating the adjusted price for delivering each of the plurality of location-based advertisements comprises automatically calculating the adjusted price based at least in part on an initial price associated with the geographic location associated with the respective location-based advertisement.

8. A method according to claim 6, wherein automatically selecting the at least one of the plurality of location-based advertisements comprises probabilistically selecting the at least one of the plurality of location-based advertisements, based at least in part on a ratio of:
the calculated adjusted price for delivering each of the plurality of location-based advertisements; and
a sum of the calculated adjusted prices for delivering the plurality of location-based advertisements.

9. A method according to claim 8, wherein automatically selecting the at least one of the plurality of location-based advertisements comprises selecting the at least one of the plurality of location-based advertisements, such that distance between each selected location-based advertisement's associated geographic location and the ascertained geographic location of the electronic communications device is less than a predetermined value.

10. A method according to claim 1, wherein calculating the adjusted price for delivering the advertisement comprises calculating a Gaussian function according to:
$$f ( x ) = b {e}^{- \frac{{( x - a )}^{2}}{2 {c}^{2}}}$$
where x is distance, a defines a location of a peak of the Gaussian function, b is a height of the peak and c is a parameter defining a shape of the Gaussian function.

11. A method according to claim 1, wherein calculating the adjusted price for delivering the advertisement comprises calculating a Gaussian function according to:
ƒ(x)=mx+b
where x is distance, m defines a rate of drop-off and b determines a value of ƒ(x) when the distance is zero.

12. A method according to claim 1, wherein calculating the adjusted price for delivering the advertisement comprises calculating the adjusted price according to a bimodal Gaussian function.

13. A method according to claim 1, wherein calculating the adjusted price for delivering the advertisement comprises calculating the adjusted price according to at least one of:
a population density;
an estimated travel time between the geographic location associated with the advertisement and the ascertained geographic location of the electronic communications device; and
an estimated travel distance between the geographic location associated with the advertisement and the ascertained geographic location of the electronic communications device.

14. A method according to claim 1, further comprising:
receiving an electronic communication from an advertiser, the electronic communication including information about the location-based advertisement and the geographic location associated with the location-based advertisement; and
storing the received information about the location-based advertisement and the geographic location associated with the location-based advertisement in a computerized database.

15. A method according to claim 14, wherein:
receiving the electronic communication from the advertiser comprises receiving an electronic communication from the advertiser, the electronic communication including the initial price associated with the geographic location associated with the location-based advertisement; and
storing the received the initial price in the database.

16. A computerized system for providing a location-based advertisement, on behalf of an advertiser, over a communications network, to an electronic communications device, the advertisement having an associated geographic location, the system comprising:
a location determination module configured to automatically ascertain a geographic location of the electronic communications device;
a price determination module coupled to the location determination module and configured to automatically calculate an adjusted price for delivering the advertisement to the electronic communications device, wherein the adjusted price is calculated based at least on:
the ascertained geographic location of the electronic communications device; and
the geographic location associated with the advertisement; and
an advertisement sender coupled to the price determination module and configured to automatically deliver the advertisement over the communications network to the electronic communications device and cause display of the delivered advertisement by the electronic communications device.

17. A system according to claim 16, wherein the price determination module is configured to automatically calculate the adjusted price for delivering the advertisement based at least in part on an initial price associated with the geographic location associated with the advertisement.

18. A system according to claim 16, further comprising an invoice generator coupled to the price determination module and configured to automatically generate an invoice that includes the automatically calculated adjusted price for delivering the advertisement.

19. A system according to claim 16, wherein the invoice generator is further configured to automatically store, in a computerized database, the automatically calculated adjusted price for delivering the advertisement, in association with an account of the advertiser.

20. A system according to claim 16, further comprising:
an advertisement request receiver coupled to the price determination module and configured to receive, from the electronic communications device, an automatically generated request for a location-based advertisement; and wherein:
the price determination module is further configured to automatically calculate the adjusted price for delivering the advertisement in response to receipt of the automatically generated request for the location-based advertisement; and
the advertisement sender is further configured to automatically deliver the advertisement in response to receipt of the automatically generated request for the location-based advertisement.

21. A system according to claim 16, wherein:
the price determination module is further configured to automatically calculate an adjusted price for delivering each of a plurality of location-based advertisements to the electronic communications device, each of the plurality of location-based advertisements having a respective associated geographic location, wherein each adjusted price is calculated based at least on:
the ascertained geographic location of the electronic communications device; and
the geographic location associated with the respective advertisement; and further comprising:
an advertisement selector coupled to the price determination module and configured to automatically select at least one of the plurality of location-based advertisements, based at least in part on the respective calculated adjusted prices for the plurality of location-based advertisements; and wherein:
the advertisement sender is further configured to automatically deliver the automatically selected at least one of the plurality of the location-based advertisements over the communications network to the electronic communications device and cause display by the electronic communications device of the automatically delivered selected at least one of the plurality of the location-based advertisements.

22. A system according to claim 21, wherein each adjusted price is calculated based at least on an initial price associated with the geographic location associated with the respective location-based advertisement.

23. A system according to claim 21, wherein the advertisement selector is further configured to automatically probabilistically select the at least one of the plurality of location-based advertisements, based at least in part on a ratio of:
the calculated adjusted price for delivering each of the plurality of location-based advertisements; and
a sum of the calculated adjusted prices for delivering the plurality of location-based advertisements.

24. A system according to claim 23, wherein the advertisement selector is further configured to automatically select the at least one of the plurality of location-based advertisements, such that distance between each selected location-based advertisement's associated geographic location and the ascertained geographic location of the electronic communications device is less than a predetermined value.

25. A system according to claim 16, the price determination module is further configured to calculate the adjusted price for delivering the advertisement according to a Gaussian function:
$$f ( x ) = b {e}^{- \frac{{( x - a )}^{2}}{2 {c}^{2}}}$$
where x is distance, a defines a location of a peak of the Gaussian function, b is a height of the peak and c is a parameter defining a shape of the Gaussian function.

26. A system according to claim 16, the price determination module is further configured to calculate the adjusted price for delivering the advertisement according to a bimodal Gaussian function.

27. A system according to claim 16, the price determination module is further configured to calculate the adjusted price for delivering the advertisement according to at least one of:
a population density;
an estimated travel time between the geographic location associated with the advertisement and the ascertained geographic location of the electronic communications device; and
an estimated travel distance between the geographic location associated with the advertisement and the ascertained geographic location of the electronic communications device.

28. A system according to claim 16, further comprising an advertisement receiver configured to:
receive an electronic communication from an advertiser, the electronic communication including information about the location-based advertisement and the geographic location associated with the location-based advertisement; and
store the received information about the location-based advertisement and the geographic location associated with the location-based advertisement in a computerized database.

29. A system according to claim 28, wherein the advertisement receiver is further configured to:
receive an electronic communication from the advertiser, the electronic communication including the initial price associated with the geographic location associated with the location-based advertisement; and
store the received the initial price in the database.

30. A computer program product for providing a location-based advertisement, on behalf of an advertiser, over a communications network, to an electronic communications device, the advertisement having an associated geographic location, the computer program product comprising a non-transitory computer-readable medium having computer readable program code thereon, the computer readable program including:
program code for automatically ascertaining a geographic location of the electronic communications device;
program code for automatically calculating an adjusted price for delivering the advertisement to the electronic communications device, wherein the adjusted price is calculated based at least on:
the ascertained geographic location of the electronic communications device; and
the geographic location associated with the advertisement; and
program code for automatically delivering the advertisement over the communications network to the electronic communications device and causing display of the delivered advertisement by the electronic communications device.
